(19) United States
(12) Patent Application Publication
(10) Pub. No.: US 2024/0175314 A1
(43) Pub. Date: May 30, 2024

(54) POSITION DAMPING DEVICE FOR A WINDOW BLIND

(71) Applicants: Hsien-Te HUANG, Taipei City (TW); Yu-Wei HUANG, Taipei City (TW)

(72) Inventors: Hsien-Te HUANG, Taipei City (TW); Yu-Wei HUANG, Taipei City (TW)

(21) Appl. No.: 18/521,179

(22) Filed: Nov. 28, 2023

(30) Foreign Application Priority Data
Nov. 29, 2022 (TW) 111213180

(51) Int. Cl. E06B 9/324

(52) U.S. Cl. CPC E06B 9/324

(57) ABSTRACT

A window blind position damping device is applied to a window blind with slat being expanded horizontally, forming a damping to a pull cord effectively when the slat is pulled down at any height, so as to define the height. The window blind position damping device includes a machine part, and an interior of the machine part has a spring scroll wheel and a position damping device which links a pull cord through a provided release idler. A damping shear pillar is vertically disposed on a base plate of the provided machine part, between an outlet of the release idler and an opening. By a provided shear ridge, the damping shear pillar shears an overrun section of the pull cord that passes through, forming the damping and thereby defining and fixing the slat at any height when being expanded.

### BACKGROUND OF THE INVENTION

### (a) Field of the Invention

The present invention relates to a damping device which can directly result in a damping effect to be used as a damping mechanism for a window blind.

### (b) Description of the Prior Art

Referring to FIG. 1 for the structure of a window blind 10, an interior of a top truss is provided with a spring motor set 20. The spring motor set 20 links outward a pull cord 13, the pull cord 13 passes through a turning obstruction unit 12, turns vertically and goes through a slat 15 to link a bottom rail 16, so as to pull up and put down the bottom rail 16. In the operation of expanding and collecting the slat 16, the bottom rail 16 is subjected to an external force and is pulled down. During the pull-down process, the pull cord 13 that is pulled down will store the elastic force of the spring motor set 20. When the bottom rail 16 is released, the elastic force of the spring motor set 20 will be fed back to the pull cord 13 which pulls up the bottom rail 16 in the opposite direction.

The abovementioned window blind 10 basically expands and collects the slat 15 horizontally. The slat 15 can be a screen type, formed by multiple screens connected up and down in equal space. A ladder rope 14 is used to adjust an orientation of the screen of the slat 15, thereby changing the orientation of light shielding.

For the abovementioned expansion operation of the window blind 10, the bottom rail 16 is pulled downward by an external force (such as a user's bare hand), and then the slat 15 will be exposed one by one sequentially to manifest an entire slat. When the slat 15 is pulled down at any half-height location, the elastic force stored in the spring motor set 20 will act onto the pull cord 13 in the opposite direction, allowing the feedback force to the pull cord 13 to pull the bottom rail 16, so that the bottom rail 16 will not fall downward. In addition, for the slat 15 to be stopped at any height of expansion that the bottom rail 16 can be fixed at a certain level, the state of that fixation is that the total weight of the bottom rail 16 and the screens loaded must be balanced to the pull force of the pull cord 13 that is subjected to the feedback of the spring motor set 20. The force of balance depends upon the elastic feedback energy of the spring motor set 20. However, as each machine part has an error in the working precision and expanding the slat 15 will be affected by the power from a front-side air flow, a moment of force will be formed on the upper end of slat 15 to swing the slat 15, which results in an outward (centrifugal direction) inertial force to form a pull force to the pull cord 13, causing a change to the breadth of slat 15 that the slat 15 will be expanded downward more. To prevent the effect of wind power and the tolerance of precision of the machine parts, two ends of the top truss 11 on the conventional window blind are provided respectively with an obstruction unit 12 which can turn simultaneously. An interior of the obstruction unit 12 is provided with at least two metal rods 17 for the pull cord 13 to wrap around back-and-forth and to form friction on the radial surface of the metal rods, which causes a damping effect to the pull cord 13, thereby achieving the damping effect to the slat 15 (including the bottom rail 16) that the slat 15 can be fixed and prevented from sliding downward.

The obstruction unit 12 is provided with two metal rods 17, with the axis parallel to each other. The metal rod 17 provides for the attachment of the pull cord 13 which also slides and wraps around the smooth circumference of the metal rod 17 in the radial direction. The degree of parallel in the assembly and arrangement of the two metal rods 17 requires a high precision of zero error; otherwise, in operation, the pull cord 13 will be deflected on a longitudinal surface of the metal rod 17, allowing the overbend section to be shifted to a pivot at a side. In addition, when the pull cord 13 is instantly subjected to an external force again, it can be deflected back and forth one time again. That back-and-forth offset will affect the stability of the expansion and collection of the slat 15 in the operation process of the pull cord 13.

When the pull cord 13 operates, as the section at the obstruction unit 12 is away from the attached end and is freer and loose, the sliding passage can slide and displace easily upon bending over and sliding. The displacement will result in the jittering to the expansion and collection process. On the other hand, as the obstruction unit 12 uses the metal rod 17 to provide the pull cord 13 to pass through vertically, the perpendicularity at one end of the spring motor set 20 is offset as it is not easy to construct and assemble the parts accurately. It is common to see that in the plastic housing of the obstruction unit 12, the surface at one side is usually worn out by the pull cord 13.

In the abovementioned system, the requirements of straightness and equality of diameter of the parts of spring motor set 20, the structure of obstruction unit 12 and the metal rod are high precision. Therefore, it is disadvantageous to the production cost of the industry. To reduce the cost of precision production, the metal rod is bent longitudinally as a “V” shape. By the recess in the center of the “V” shape part, the pull cord can be guided by the slants on two sides to run through in the middle at a fixed point. However, as the recess keeps scratching at the fixed point, the recess is worn out easily to damage the section of the pull cord 13.

Depending upon the linear layout of wiring, the two ends of the wiring are combined with or attached to the attached object. For the swinging reaction distributed in the section, the elastic change rate for the middle section is larger and thus the middle section is easy to shift horizontally and its stress distribution is looser, like a steel cable for tying and hanging an object or a string of musical instrument. The middle section can have a larger freedom of swinging by an external force, and this phenomenon can reflect to the window blind 10, where the front and rear end of the pull cord 13 are combined with and attached to the spring motor set 20 and the bottom rail 16 respectively, and the section close to the spring motor set 20 is more compact.

In the present invention, the compact section is implemented with the damping interference, which can achieve the damping effect more explicitly. In the present design, the space location where the damping occurs is improved accordingly.

Under the same benefit, the present invention uses a simplest design to achieve the same purpose. In addition, the space of a corner part of the obstruction unit 12 can be avoided, and the system noise can be reduced as an element with higher sliding ratio, such as pulley, can be used as the turning part.

### SUMMARY OF THE INVENTION

A primary object of the present invention is to provide a position damping device for a window blind slat, which is applied to a window blind with the slat being expanded and collected horizontally, resulting in damping to a pull cord effectively to define a height position when the slat is pulled down at any height. The position damping device is provided with a machine part, whereas an interior of the machine part is provided with a spring scroll wheel and a position damping device which links an outside pull cord by a provided release idler. The machine part is provided with a base plate, and at least a damping shear pillar with a shear ridge is disposed between an outlet of the release idler and an opening. By the provided shear ridge, the damping shear pillar can shear the line section of the pull cord that passes through the release idler, resulting in multidirectional components of force, so as to achieve the required damping effect.

A second object of the present invention is to provide a position damping device for a window blind, wherein the cross section of the damping shear pillar takes a proper geometric shape, primarily a triangular shape, a hexagonal shape, a water-drop shape, a square shape, or an eye shape. In addition, a shear ridge is formed on the longitudinal surface of the damping shear pillar, providing for shearing the line section of the pull cord that passes through the damping shear pillar. An outer corner of the shear ridge is provided with an arc-shaped cross section.

A third object of the present invention is to provide a position damping device for a window blind, wherein a lever is disposed on an opposite direction to a place on which the damping shear pillar provides for the pull cord to pass through, forming a line section of the pull cord that is confined without falling out.

A fourth object of the present invention is to provide a position damping device for a window blind, wherein the damping shear pillar provides the pull cord to shear through in the direction of the opening, and a planar location on the base plate area where an overrun section of the pull cord is forcefully bent is vertically provided at least with a turning guide-rod in a shape of straight bar with a longitudinal line thereof parallel to the damping shear pillar.

A fifth object of the present invention is to provide a position damping device for a window blind, wherein a planar area on the base plate where the damping shear pillar is opposite to the opening is provided at least with a turning guide-rod which can bend an overrun section of the pull cord once again.

A sixth object of the present invention is to provide a position damping device for a window blind, wherein the window blind includes a top truss, and an interior of the top truss is provided with the abovementioned position damping device. The position damping device at least links a pull cord, the pull cord passes through an overbend unit and is lowered down to transfix and combine with a slat. A lower part of the slat is sealed by a bottom rail, and the bottom rail is engaged at a lower end of the pull cord. The bottom rail is linked by the pull cord to expand and collect the slat. On the other hand, two ends of a top rail can be provided with any form of overbend element for turning the pull cord, such as a torus, a rod unit, or a wheel unit.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a front view of a conventional window blind.

FIG. 2 shows a structural view of a position damping device, according to the present invention.

FIG. 3 shows a bottom view of the position damping device, according to the present invention.

FIG. 4 shows state view of a deformation-stress system, according to the present invention.

FIG. 5 shows a schematic view of operation of a damping shear pillar to a pull cord, according to the present invention.

FIG. 6 shows another schematic view of the operation of the damping shear pillar to the pull cord, according to the present invention.

FIG. 7 shows yet another schematic view of the operation of the damping shear pillar to the pull cord, according to the present invention.

FIG. 8 shows a schematic side view of an implementation of a lever, according to the present invention.

FIG. 9 shows a schematic view of a deformation-stress system formed by implementing two shear ridges, according to the present invention.

FIG. 10 shows a schematic view of an implementation of a hexagonal shear ridge in FIG. 7, according to the present invention.

FIG. 11 shows another schematic view of the implementation of the hexagonal shear ridge in FIG. 7, according to the present invention.

FIG. 12 shows a front view of the present invention that is implemented onto a window blind.

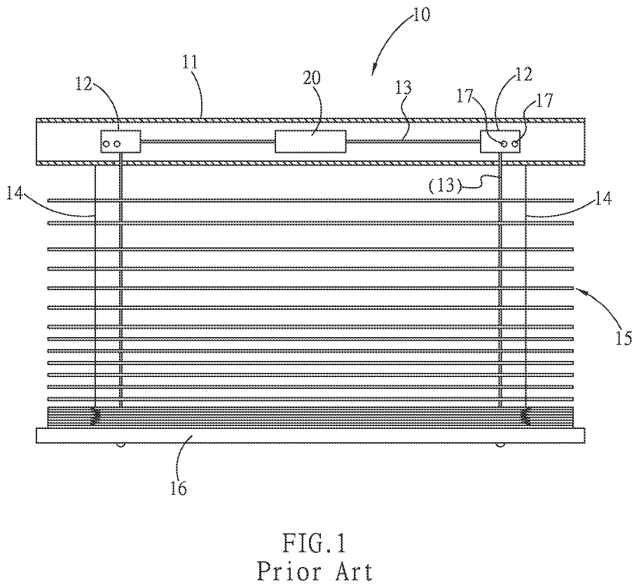

### DETAILED DESCRIPTION OF THE PREFERRED EMBODIMENTS

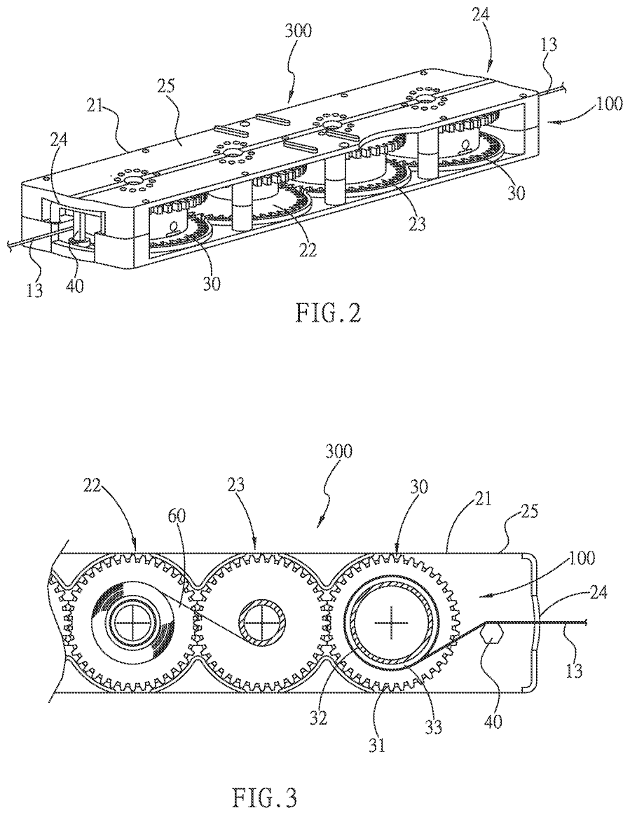

Referring to FIG. 2 and FIG. 3, a position damping device 300 is a machine part 21 formed by two long base plates 25 combined up and down. A front and rear end of the machine part 21 are provided respectively with an opening 24 for a pull cord 13 to go through, and a center of the machine part 21 is provided with a spring scroll wheel 100 having an elastic feedback function. The spring scroll wheel 100 includes a power wheel 22 which links a feedback wheel 23 through a reed 60 having an elastic feedback function. The power wheel 22 and the feedback wheel 23 are gnawed outward with a left and right release idler 30 (the definition of left and right is manifested as a view angle in FIG. 2). The two release idlers 30 provide for linking and collecting the pull cord 13 on two sides. The axis of every abovementioned wheel is parallel to each other and perpendicular to the base plate 25, and all the abovementioned wheels are arranged in a series along a longitudinal surface of the base plate 25. The release idler 30 expands and collects the pull cord 13, and an inner circumference of the release idler 30 is a hub surface 32, with a slot 33 formed between the hub surface 32 and an outer spoke edge 31. The slot 33 provides for winding the pull cord 33. Between the outlet of the slot 33 and the opening 24, a damping shear pillar 40, a longitudinal line of which is parallel to the release idler 30, is vertically disposed on a plane of the base plate 25. The damping shear pillar 40 is disposed in a region where the section of the pull cord 13 can shear and turn out of the opening 24. By providing directly the damping shear pillar 40 in that region, the more compact pull cord 13 close to a head end of the release idler 30 can be sheared, and an effective damping action can be achieved by the compact reaction force of that line section of the pull cord 13. In addition, the contact force to the pull cord 13 that is disposed out of the slat, due to the contact of an additional external force, will not be easily transmitted to the location of the damping shear pillar 40 to stabilize the damping effect, as the contact force is absorbed by the redundant line section of the pull cord 13.

Referring to FIG. 4, the abovementioned damping shear pillar 40 shears the surface of the wound pull cord 13 (the shear force is a reaction force and is a detention force P which is formed when the pull cord 13 is pulled by an external force, with the detention force P responding to the shear point) to bend the pull cord 13. In bending the pull cord 13, a distribution of deformation-stress system R will be acquired, wherein the reaction force F from the damping shear pillar 40 will shear the corresponding surface of the pull cord 13. The pull cord 13 is twisted by plural filaments, the cross section is a line thread interwoven by plural wires of filaments, the filaments are flexible, and interwoven gaps are disposed among plural wires of filaments; therefore, the shear point will be concaved and deformed when being sheared radially by the abovementioned shear force. The deformation will then form an inflectional component of force C, and the inflectional component of force C will affect the working efficiency of the detention force P of the pull cord 13, resulting in the damping effect.

At the same time after the pull cord 13 overbends and shears by the abovementioned damping shear pillar 40, an overbent outer curved surface of the pull cord 13 will result in a longitudinal tension T parallel to the detention force P (like an ordinary elastic tubing, the overbent outer curved surface will form a tension parallel to the tubing, whereas an inner curved surface will result in an extrusion force, after being bent by an external force).

The pull cord 13 is a line thread made by twisting the filaments. When the line section is subjected to an external force radially and is squeezed, a resilient force will be formed radially. In the overbend system, an end of the pull cord 13 is pulled by the detention force P, and the other end is formed with a reverse pull force symmetrically. An X-axis component of force and a Y-axis component of force are formed at the overbent angle at two ends of the pull cord 13, and the shear point of the damping shear pillar 40 where the resulted components of force are combined results in a normal force to act on the damping shear pillar 40. The normal force presses the thick fibers that are stacked inside the pull cord 13, so that the surface of the interwoven fibers that are attached on the surface of the damping shear pillar 40 can acquire a back pressure in the normal direction, acting on a slip cutting surface of the damping shear pillar 40 to form a shear friction force which is converted into the damping.

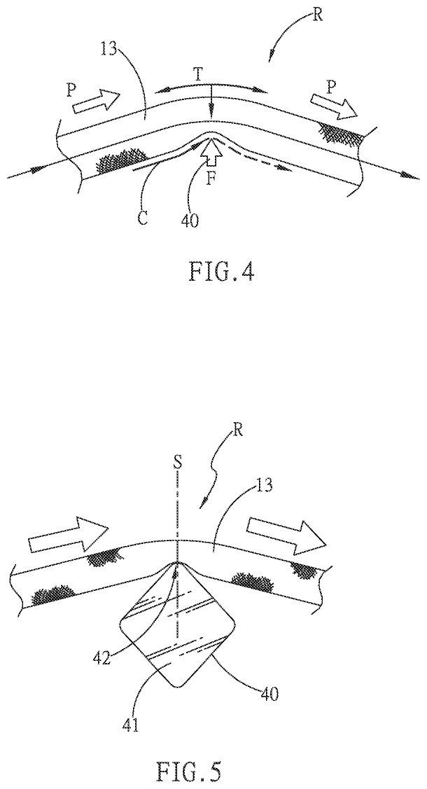

After test, the structural configuration and the benefit of deployment of the damping shear pillar 40 is described below. First of all, as shown in FIG. 5, the damping shear pillar 40 is basically a pillar 41 in a shape of a straight bar, the outer longitudinal surface is provided at least with a shear ridge 42, and the shape of the shear ridge 42 can be the structure that shears the line section of the pull cord 13. The cross section of the damping shear pillar 40 can be a square or rhombus, and the shear ridge 42 is longitudinally distributed on the outer surface of the damping shear pillar 40, forming a deformation-stress system R on the overrun location of the pull cord 13. In addition, it is the best that the shear ridge 42 shears the pull cord 13 at the orientation of normal S.

An inner end (not shown in the drawing) of the pull cord 13 is fixed in the slot 33 close to the hub surface 32. As shown in FIG. 3, as the line section is wound by the slot 33, the diameter of the line section will be changed due to the accumulation of the layers of line roll, so that the orientation at which the pull cord 13 enters into the shear ridge 42 will alter the contingence angle of the pull cord 13 relative to the shear ridge 42 slightly due to the change in diameter of the line section. However, in practice, this slight change will not affect the damping function significantly.

If the included angle of the shear ridge 42 is small, then the shear depth to the line section of the pull cord 13 will increase. On the other hand, if the included angle is large, then the shear depth will be shallow, and the resulted damping energy is small, which is dependent upon the system requirement. Moreover, the corner end of the shear ridge 42 provides for the sliding of the pull cord 13. Therefore, microscopically, the cross section of that corner end is an arc-shaped cross section, which avoids the pull cord to be cut off by an acute angle. In addition, under a premise that the line section of the pull cord 13 will not be damaged, the larger the curvature of the arc-shaped cross section is, the larger the damping effect occurs.

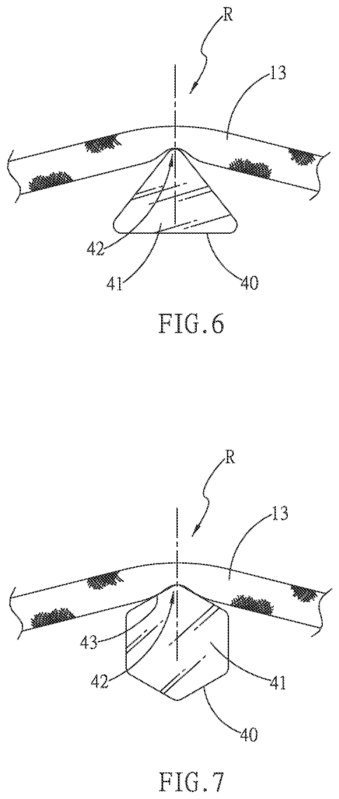

Referring to FIG. 6, the cross section of the damping shear pillar 40 can be any geometric shape, including the abovementioned rhombus or triangle. The longitudinal surface of the damping shear pillar 40 can be formed with one or more than on shear ridge 42 to result in a deformation-stress system R to the line section that the pull cord 13 passes through, forming the damping to the line section of the pull cord 13.

Referring to FIG. 7, the cross section of the damping shear pillar 40 can be a polygon, such as a hexagon, forming at least one shear ridge 42 and two slip cutting surfaces 43. The at least one shear ridge 42 provides the overrun section of the pull cord 13 to result in a deformation-stress system R, causing the damping to the running of the pull cord 13. In addition, during the change in orientation when the pull cord 13 runs, the slip cutting surfaces 43 can very likely provide the line section of the pull cord 13 to slip cutting, which also assists in the friction damping. On the other hand, the running orientation of the pull cord 13 can be also arranged that the pull cord 13 is sheared simultaneously by the neighboring shear ridge 42, allowing the slip cutting surface 43 between the two shear ridges 42 to be subjected to a dynamic pressure; the damping is primarily from the two shear ridges 42.

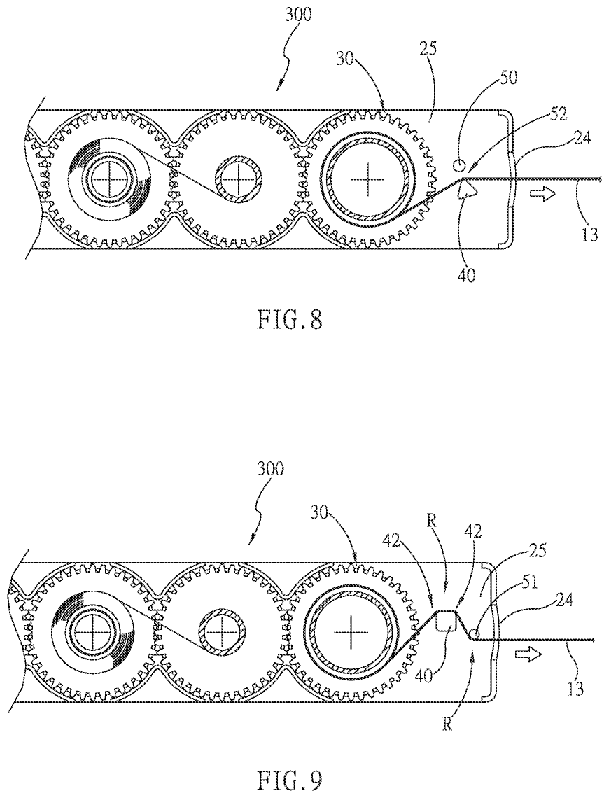

Referring to FIG. 8, a lever 50 is disposed vertically in the direction opposite to a location where the damping shear pillar 40 provides for the overrun of the pull cord 13 and in the base plate 25 area parallel to the axis of the release idler 30, forming a transitional passage 52, so that under an abnormal condition, such as when the pull cord 13 loses the pull force and is loose when the window blind is dismantled, the line section of the pull cord 13 that passes through will not escape from the damping shear pillar 40 at a large distance.

In the present invention, the provided damping shear pillar 40 is provided at least with a shear ridge 42, forming the damping effect to the opposite surface of the pull cord 13 that passes through, as shown in FIG. 5. No matter one or more than two shear ridges 42 is provided by the damping shear pillar 40, a turning guide-rod 51 (as shown in FIG. 9) can be disposed on the base plate 25 between the opening 24 and the vertically disposed damping shear pillar 40 where the running curvature of the pull cord 13 is enlarged, with a longitudinal surface of the turning guide-rod 51 parallel to the damping shear pillar 40. Therefore, for the overrun section of the pull cord 13 that passes through the damping shear pillar 40, the abutting length to the surface of the shear ridge 42 can be increased or the overrun section can be sheared simultaneously by two neighboring shear ridges 42, thereby increasing the damping function. The method of provision is described below as shown in the drawing.

The cross section of the abovementioned damping shear pillar 40 can be any shape. Normally it can take a triangular shape, a square shape, a rhomboidal shape, a hexagonal shape or a polygonal shape for convenience, with one of them being used on demand. The shape can be arranged that one or two shear ridges 42 face toward the overrun passage of the pull cord 13 to shear the line section of the pull cord 13.

The damping shear pillar 40 can be a straight rod in any cross section. The surface is at least protruded with more than one shear ridge 42 that is parallel to the axis of the release idler 30. The shear ridge 42 faces toward the overrun passage of the pull cord 13 to shear the line section of the pull cord 13.

Referring to FIG. 9. The damping shear pillar 40 is a square, forming plural shear ridges 42 to bend and shear the pull cord 13 at the outlet of the release idler 30. The shear is executed by at least two shear ridges 42, and by the execution of the two shear ridges 42, the energy accumulation of the deformation-stress system R can be increased. In addition, to allow the overbend section of the pull cord 13 to be sheared by the two shear ridges 42, the plane on the base plate 25 toward the opening 24 is provided vertically with a turning guide-rod 51, a longitudinal line of which is parallel to the axis of the release idler 30, to forcefully bend the section of the pull cord 13 that shears through the damping shear pillar 40 at a large angle. Similarly, the existence of the turning guide-rod 51 will also cause the damping to the pull cord 13. If a larger damping is needed, the turning guide-rod 51 can be also replaced by one damping shear pillar 40, allowing the sheared pull cord 13 to form another deformation-stress system R.

For a hexagonal damping shear pillar 40, there can be two installation angles to change the damping energy. For the change in angle, please refers to the drawing below.

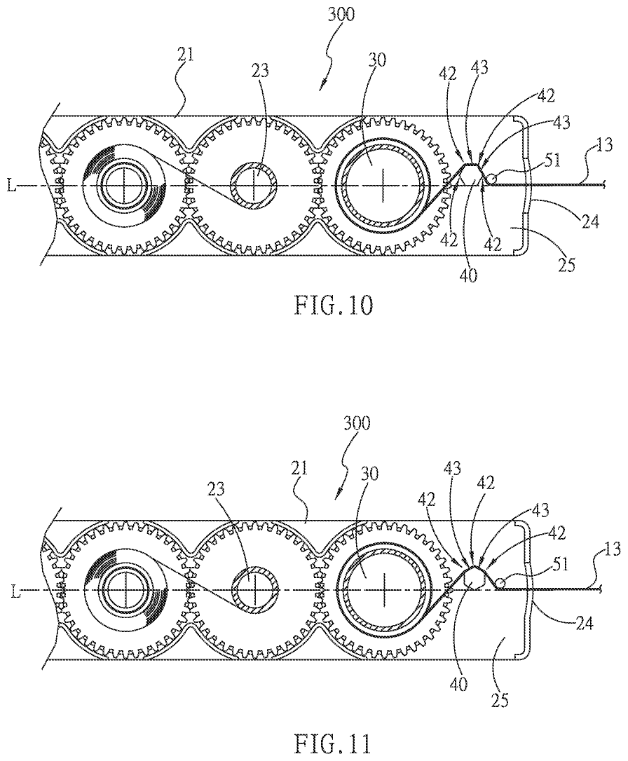

Referring to FIG. 10, a hexagonal damping shear pillar 40 is disposed in the position damping device 300 on the base plate 25 close to the opening 24 and parallel to the axis of the feedback wheel 23. A side of the damping shear pillar 40 is a center line L aligned with the position damping device 300, forming a parallel slip cutting surface 43 at the upper end and plural equiangular shear ridges 42 on two sides. The pull cord 13 comes out of the feedback wheel 23, contacts the upper-left shear ridge 42 first, and then connects to the upper-right shear ridge 42 through the parallel slip cutting surface 43, achieving the overrun method containing two corners and at least one slip cutting surface.

The right-end shear ridge 42 is defined by a turning guide-rod 51 to result in shear. If the turning guide-rod 51 is not to be implemented, the pull cord 13 can be also made to wrap around the left-end shear ridge 42, the upper-left shear ridge 42, and the two neighboring slip cutting surfaces 43, which results in a lighter damping.

If the damping shear pillar 40 is disposed at a location close to the feedback wheel 23, then the outlet angle of the feedback wheel 23 can allow the pull cord 13 to shear on the left shear ridge 42 first, then shear the upper-left shear ridge 42, and then connects to the upper-right shear ridge 42 through the slip cutting surface 43. Added by the definition of the turning guide-rod 51, the pull cord 13 can shear through the right shear ridge 42 to form multiple damping shear points, providing an accumulated damping function to the pull cord 13 due to bending and shearing.

Referring to FIG. 11, a damping shear pillar 40 is disposed in the position damping device 300 on the base plate 25 close to the opening 24 and parallel to the feedback wheel 23. The diagonal line of the damping shear pillar 40 is a vertical center line L, and therefore, the outlet of the feedback wheel 23 first shears the upper-left shear ridge 42 and the top-end shear ridge 42. As the right end is defined by the turning guide-rod 51, the pull cord 13 is sheared by the upper-right shear ridge 42. In the process, the pull cord 13 passes through two oblique slip cutting surfaces 43. This damping method can provide for use in a medium-load window blind system. The damping shear pillar 40 is disposed at a location close to the feedback wheel 23, allowing the outlet of the feedback wheel 23 to shear the upper-left shear ridge 42 as a basis. The upper-right shear ridge 42 is also defined by the turning guide-rod 51 to result in shear. If the turning guide-rod 51 is not to be implemented, then at least upper-left and top shear ridges 42 can result in the overbend shearing, forming another modulation of the damping energy.

In the abovementioned two implementations, the location of the damping shear pillar 40 that is disposed close to the feedback wheel 23 basically allows the left-side shear ridge 42 to result in shear. However, the damping shear pillar 40 can be also moved away from the feedback wheel 23, allowing the upper shear ridge 42 or slip cutting surface 43 to result in a light damping.

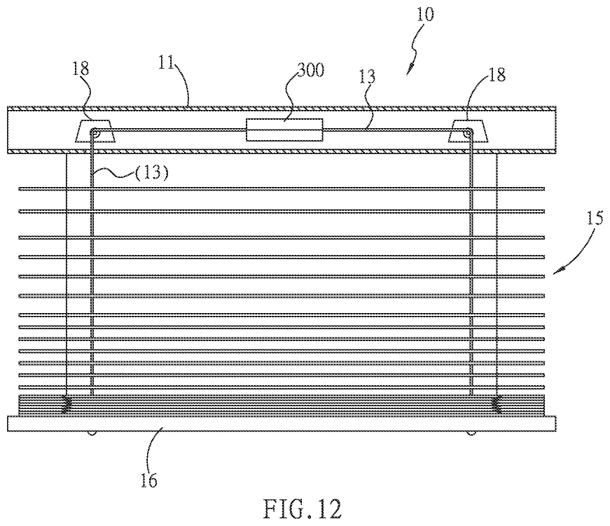

Referring to FIG. 12, the position damping device 300 completed by the concepts in the abovementioned FIG. 2 to FIG. 11 is implemented to the window blind 10 with the slat 15 expanded and collected horizontally. The position damping device 300 is disposed in a middle inside the top truss 11, the outer ends of the pull cords 13 linking at two sides of the top truss 11 go through the overbend units 18 on two sides of the top truss 11 for the pull cord 13 to overbend, and turn downward to transfix with the slat 15. The tail end of the pull cord 13 is then fixedly combined at the lower-end bottom rail 16, and the upper side of the bottom rail 16 seals the lower part of the slat 15. By the dragging force of the position damping device 300 against the pull cord 13, the bottom rail 16 of the slat 15 can be stopped effectively when the slat 15 is expanded at any height.

When a user is to adjust the shielded height of the slat 15, he or she uses bare hands to exert a force to the bottom rail 16 to change its vertical position. When the bottom rail 16 is pushed upward, the line section of the pull cord 13 close to the damping shear pillar 40 (as shown in FIG. 5 to FIG. 11) will lose the tension and the damping force will disappear. Therefore, following the elastic feedback force stored in the provided spring scroll wheel 100, the release idler 30 is acted upon to collect the pull cord 13.

On the other hand, when the slat 15 is to be lowered down, the user uses the bare hands to pull down the bottom rail 16. When the exerted force is larger than the total of the entire reaction force of the position damping device 300 and the friction force of the window blind 10, the slat 15 can be lowered down. After the height of the bottom rail 16 is selected, the bottom rail 16 can be stopped by the damping function of the position damping device 300.

The implemented overbend unit 18 is a mechanism providing for the pull cord 13 to overbend downward, and can be an idler or a planar circular rod.

In the present invention, a damping shear pillar is disposed vertically between the release idler and the opening, with the longitudinal line of the damping shear pillar parallel to the release idler. In structure, the damping shear pillar is disposed inside the base plate of the machine part; and basically, just only a single damping shear pillar with the shear ridge is able to result in the deformation-stress system to the pull cord, achieving the damping requirement of the system.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A position damping device for a window blind, being applied to a window blind with slat being expanded and collected horizontally, resulting in damping to a pull cord effectively to define a height position of the slat when the slat is lowered down at any height, comprising
a machine part which is formed by two base plates combined up and down, with two ends of the machine part being provided with an opening to connect the interior;
a spring scroll wheel, an axis of which is vertically pivoted on the base plate in the abovementioned machine part, with the spring scroll wheel including a reed to link a power wheel and a feedback wheel, and with the power wheel and the feedback wheel being gnawed outward with two release idlers to release and collect a pull cord; and
a longitudinal surface, which is protruded with a straight-bar shaped damping shear pillar having a shear ridge, with a longitudinal line of the damping shear pillar being parallel to the axis of the release idler, with the damping shear pillar being disposed vertically on a base plate between an opening and an outer circumference of the release idler in an outlet direction of a slot, and a planar angle of the provided shear ridge facing toward the overrun passage of the pull cord in work.

2. The position damping device for a window blind, according to claim 1, wherein a corner end of the shear ridge is provided with an arc-shaped cross section.

3. The position damping device for a window blind, according to claim 1, wherein a cross section of the damping shear pillar is a rhomboid, a square or a triangle, and a corner end is a shear ridge.

4. The position damping device for a window blind, according to claim 1, wherein the longitudinal surface of the damping shear pillar is protruded with two shear ridges, and the angles of the two shear ridges face toward the running passage of the pull cord in work.

5. The position damping device for a window blind, according to claim 1, wherein the damping shear pillar is a straight rod in any shape of cross section, and a side on the longitudinal surface is protruded with a shear ridge parallel to the longitudinal surface.

6. The position damping device for a window blind, according to claim 5, wherein the polygon is preferably a hexagon.

7. The position damping device for a window blind, according to claim 6, wherein a side of the hexagonal damping shear pillar is a center line that is aligned with the machine part.

8. The position damping device for a window blind, according to claim 6, wherein a diagonal line of the hexagonal damping shear pillar is a center line parallel to the machine part.

9. The position damping device for a window blind, according to claim 1, wherein an opposite direction where the damping shear pillar provides for the shearing of the pull cord is parallel provided with a vertical lever to form a transitional passage.

10. The position damping device for a window blind, according to claim 1, wherein the damping shear pillar provides the pull cord to shear through in the direction of the opening, and a planar location on the base plate area where an overrun section of the pull cord is forcefully bent is vertically provided with a turning guide-rod in a shape of straight bar with a longitudinal line thereof parallel to the damping shear pillar.

11. A window blind with slat being expanded and collected horizontally, resulting in damping to a pull cord effectively to define a height position of the slat when the slat is lowered down at any height, comprising
a top truss, an interior of which is provided with a position damping device as described in claim 1;
a pull cord, an end of which links to the position damping device, with a free end of the pull cord being lowered down to transfix and combine with a slat through an overbend unit; and
a bottom rail, which is assembled at a lower end of the pull cord to seal the lower part of the slat.
